(19) United States
(12) Patent Application Publication
(10) Pub. No.: US 2009/0276319 A1
(43) Pub. Date: Nov. 5, 2009

(54) ADVERTISEMENT MANAGEMENT AND DISPLAY SYSTEM

(76) Inventors: Emanuel Lungu, Boynton Beach, FL (US); Daniel Lungu, Lake Worth, FL (US); Arkley Warren Smith, III, Loxahatchee, FL (US)

Correspondence Address: GOLD & RIZVI, P.A., 600 N. PINE ISLAND ROAD, SUITE 450, PLANTATION, FL, 33324-1311, US

(21) Appl. No.: 12/113,185

(22) Filed: Apr. 30, 2008

(51) Int. Cl. G06Q 30/00; A47B 37/00; G06F 3/041

(52) U.S. Cl. 705/14.73; 108/50.11; 345/173

(57) ABSTRACT

An advertisement management and display system includes marketing management software, a client advertisements database communicating with the marketing management software, at least one table and at least one content display device carried by the at least one table and communicating with the marketing management software. The client advertisements database is adapted to store at least one advertisement, the marketing management software is adapted to receive the at least one advertisement from the client advertisements database and the at least one content display device is adapted to receive the at least one advertisement from the marketing management software and display the at least one advertisement.

### BACKGROUND OF THE INVENTION

1. Field of the Invention

The present invention relates generally to distribution and display of advertisements. More particularly, the present invention relates to an advertisement management and display system, which is adapted to electronically receive advertisements from one or multiple advertisers and display the advertisements on a table with electronic display capability.

2. Discussion of the Related Art

Broadcast programming is available through radio and television airwave broadcasts, cable providers, satellite transmissions and other communication channels. For years, televisions have provided viewers with a variety of entertainment, news, educational programs and advertisements. With the advent of personal computers and the Internet, these media have become almost universally available.

Advertisements for the goods or services of a business can be presented to potential customers by printing the advertisements on a substrate such as a newspaper, for example, or alternatively by displaying the advertisements via television programming during breaks in a broadcasted program, for example, or on a personal computer via the Internet. Advertisements on printed media are static and have a relatively limited capacity to engage the attention and interest of potential customers. On the other hand, advertisements which can be targeted to potential customers in an electronic format such as via television or Internet, for example, are dynamic and have a large capacity for customization as well as the ability to entertain while promoting goods or services.

Therefore, an advertisement management and display system which is adapted to display advertisements on a table with electronic display capability is needed.

### SUMMARY OF THE INVENTION

The invention is directed to an advertisement management and display system. The advertisement management and display system is particularly adapted to electronically receive advertisements from one or multiple advertisers and display the advertisements on a table with electronic display capability. The table can be placed in a restaurant, cafeteria, mall, club, hospital waiting area, coffee shop, airport and other area in which persons stand or sit at a table in order to advertise goods and services to potential customers.

In one general aspect of the present invention, the advertisement management and display system may include:

marketing management software;

a client advertisements database communicating with the marketing management software;

at least one table; and

at least one content display device carried by the at least one table and communicating with the marketing management software. The client advertisements database is adapted to store at least one advertisement, the marketing management software is adapted to receive the advertisement or advertisements from the client advertisements database and the content display device or devices is/are adapted to receive the advertisement or advertisements from the marketing management software and display the advertisement or advertisements.

In a further aspect of the present invention, a marketing company may communicate with the marketing management software and may be adapted to modify the at least one advertisement.

In still a further aspect of the present invention, at least one advertiser may interface with the client advertisements database.

In another aspect of the present invention, the at least one content display device may include a plurality of content display devices.

In yet another aspect of the present invention, the at least one table may include a table top and a plurality of table legs extending from the table top and the at least one content display device may be carried by the table top.

In still another aspect of the present invention, the at least one table may include a table top and a central table top support extending from the table top and the at least one content display device may be carried by the table top.

In another aspect of the present invention, the at least one content display device may include a display cavity provided in the at least one table; a display screen provided in the display cavity; a circuit board connected to the display screen; and a power cord connected to the circuit board.

In still another aspect of the present invention, the display screen may include a touch-activated display screen.

In another aspect of the present invention, a support tray may be carried by the at least one table.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective view of a table with electronic display capability which is suitable for implementation of an illustrative embodiment of the advertisement management and display system;

FIG. 2 is a schematic diagram of an advertisement management and display system;

FIG. 3 is a perspective view of an alternative embodiment of a table with electronic display capability which is suitable for implementation of an illustrative embodiment of the advertisement management and display system;

FIG. 4 is a perspective view of an alternative split-screen embodiment of a table with electronic display capability which is suitable for implementation of an illustrative embodiment of the advertisement management and display system;

FIG. 5 is a perspective view a multi-screen embodiment of a table with electronic display capability which is suitable for implementation of an illustrative embodiment of the advertisement management and display system;

FIG. 6 is a top view of the table with electronic display capability illustrated in FIG. 1;

FIG. 7 is a longitudinal sectional view, taken along section lines 7-7 in FIG. 6, of the table with electronic display capability;

FIG. 8 is a longitudinal sectional view of a table with electronic display capability having a magnified lens;

FIG. 9 is a top view of a table with electronic display capability with multiple, discrete advertisement display sections presented on the table with electronic display capability;

FIG. 10 is a perspective view of another illustrative embodiment of the table with electronic display capability, with a support tray provided on a table top of the table and various items supported by the support tray;

FIG. 11 is a perspective view of another illustrative embodiment of the table with electronic display capability, with a grid-type support tray provided on a table top of the table and various items supported by the support tray;

FIG. 12 is a schematic diagram of a control system which is suitable for implementation of an illustrative embodiment of the advertisement management and display system;

FIG. 13 is a perspective view of another illustrative embodiment of the table with electronic display capability, with a content display device illustrated in a pivoted configuration with respect to a table top; and

FIG. 14 is a perspective view of a bar table embodiment of the table with electronic display capability.

Like reference numerals refer to like parts throughout the several views of the drawings.

### DETAILED DESCRIPTION OF REPRESENTATIVE EMBODIMENTS

Shown throughout the Figures, the invention is directed to an advertisement management and display system which is adapted to receive advertisements from one or multiple advertisers and display the advertisements on a table with electronic display capability in order to advertise products and/or services offered by the advertisers to potential customers. The advertisement management and display system is particularly suitable for displaying advertisements on tables in restaurants, cafeterias, malls, clubs, hospital waiting areas, coffee shops, airports and other areas in which persons stand or sit at a table.

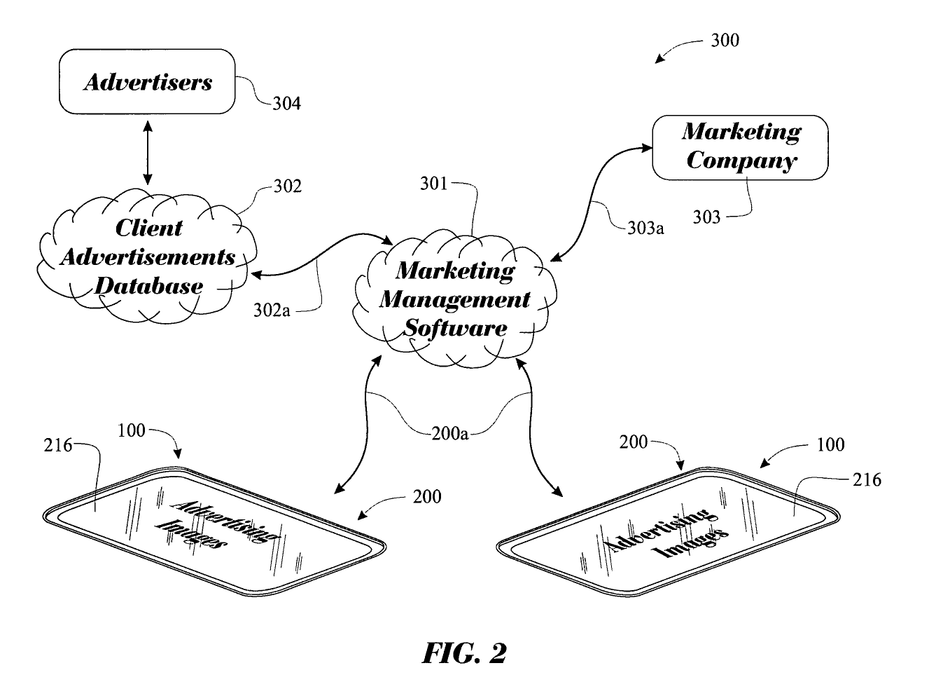

Referring initially to FIG. 2 of the drawings, an illustrative embodiment of the advertisement management and display system, hereinafter system, is generally indicated by reference numeral 300. The system 300 includes marketing management software 301. A client advertisements database 302 interfaces with the marketing management software 301 through an information transfer pathway 302a. At least one advertiser 304 communicates with the client advertisements database 302. Each advertiser 304 may be an entity which offers goods and/or services to potential customers and which seeks to advertise those goods and/or services to the potential customers. In some embodiments, a marketing company 303 may interface with the marketing management software 301 through an information transfer pathway 303a. Through an information transfer pathway 200a, the marketing management software 301 interfaces with at least one table with electronic display capability 100, hereinafter table, which will be hereinafter described.

As will be hereinafter described, the table 100 may be placed in a restaurant, cafeteria, mall, club, hospital waiting area, coffee shop, airport or other area in which potential customers of the goods and/or services offered by the advertisers 304 stand or sit around the table 100. The advertisers 304 electronically store advertisements which promote the goods and/or services offered by each advertiser 304 on the client advertisements database 302. The advertisements are transferred to the marketing management software 301 and ultimately, to the table 100, on which the advertisements are presented for the purpose of promoting those goods and/or services to the potential customers (not illustrated) as the potential customers stand or sit around the table 100.

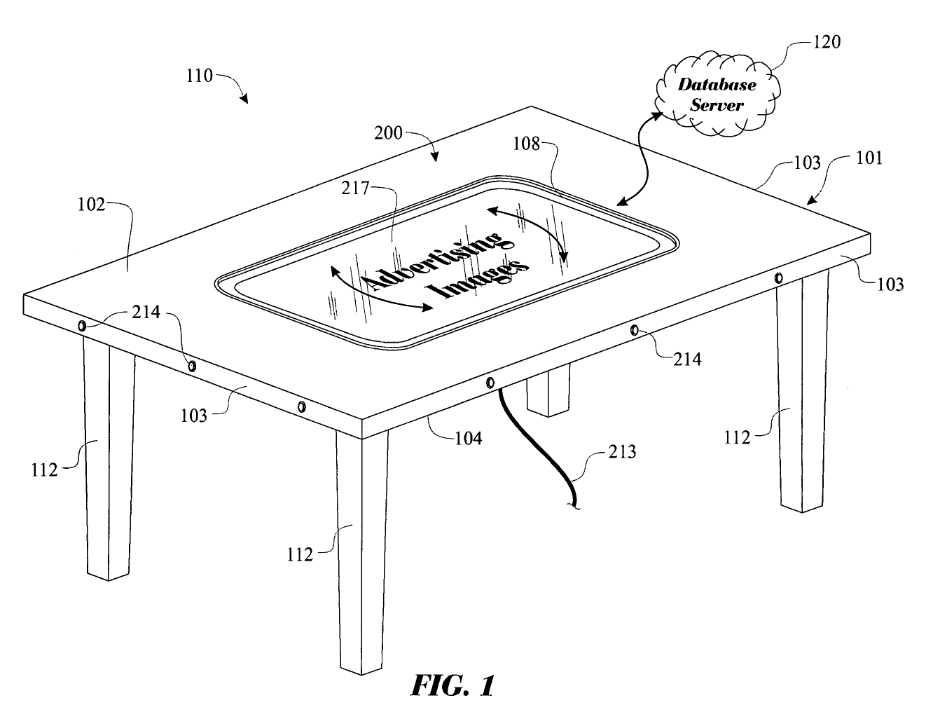

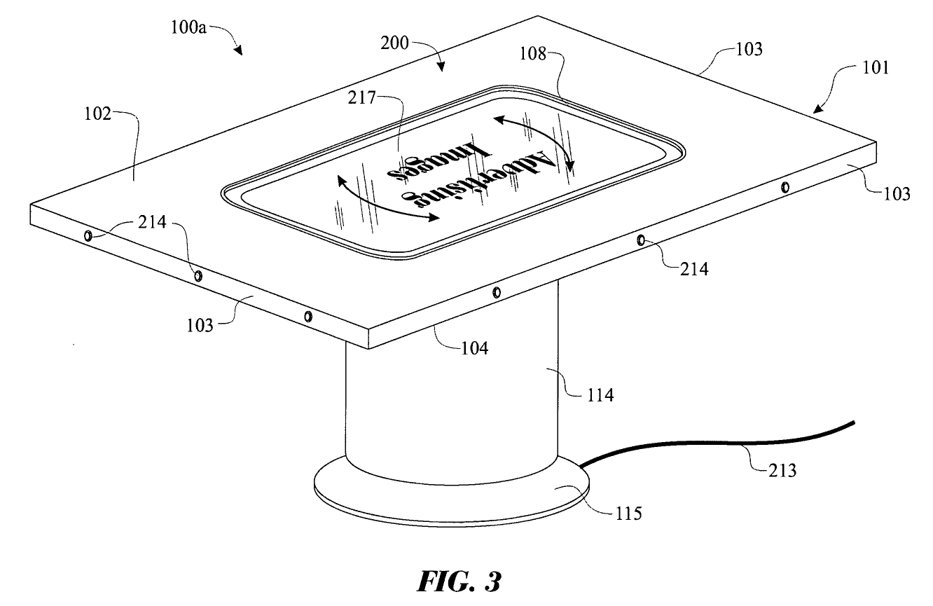

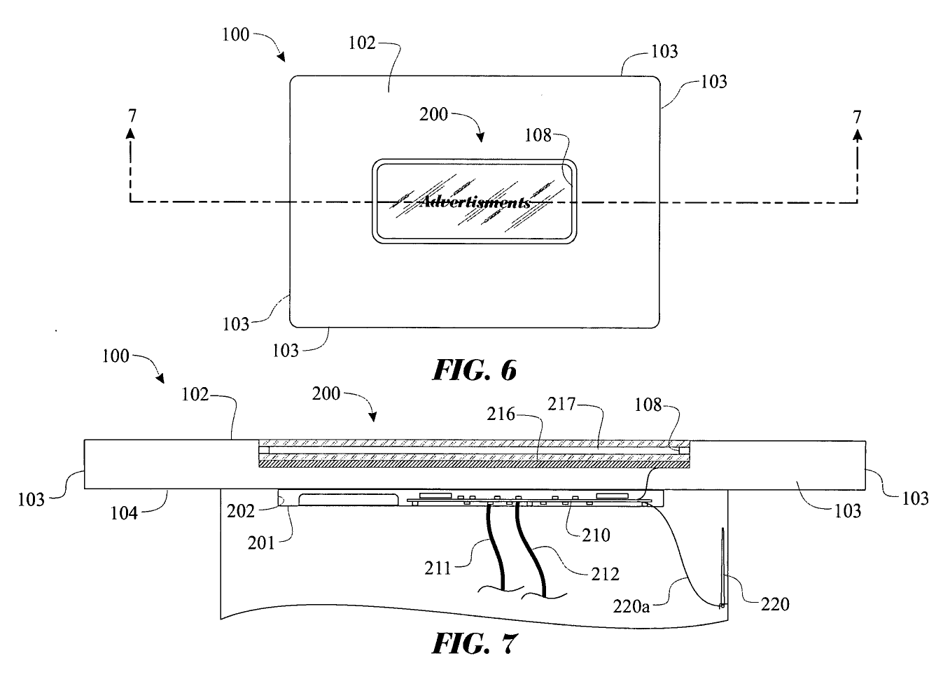

Referring next to FIGS. 1 and 3-8 of the drawings, various illustrative embodiments of the table are illustrated. A first illustrative embodiment of the table 100 is illustrated in FIGS. 1, 6 and 7. The table 100 includes a table top 101 which may have a generally elongated, rectangular configuration or other suitable alternative configuration such as triangular, octagonal or hexagonal, for example. The table top 101 may include a top surface 102; side surfaces 103 extending from the top surface 102; and a bottom surface 104 extending from the side surfaces 103 in generally parallel, spaced-apart relationship with respect to the top surface 102. Multiple table legs 112 may extend from the table top 101 to support the table top 101 on a floor or other support surface (not illustrated). As illustrated in FIG. 3, in an alternative illustrative embodiment of the table 100a, a central table top support 114 extends downwardly from generally the center of the table top 101. A support base 115 may extend outwardly from the table top support 114 to stabilize the table top support 114 on the support surface (not illustrated). The table 100 can be constructed using any of a variety of materials including but not limited to wood, foam, laminate, stone, plastic and/or metal.

A content display device 200 is provided on the table top 101 of the table 100. As illustrated in FIG. 7, in some embodiments the content display device 200 may include a component compartment 201 which may be provided on or in the bottom surface 104 of the table top 101 or in any suitable alternative location. The component compartment 201 includes a component compartment interior 202 which is sized and configured to contain a circuit board 210 and other functional components of the content display device 200. A power cable 211 may be electrically connected to the circuit board 210 to supply electrical power to the circuit board 210. The power cable 211 may be connected to a power cord 213 (FIG. 1) which is adapted for connection to an electrical outlet (not illustrated). A data cable 212 may be connected to the circuit board 210 for electronic transfer of advertisement data to the circuit board 210, as will be hereinafter described.

A display cavity 108 may be provided in the top surface 102 of the table top 101. A display screen 216 of the content display device 200 is recessed in the display cavity 108. A transparent screen cover panel 217, which may be PLEXIGLAS (trademark) or other clear laminate, may be provided in the display cavity 108 over the display screen 216. In some embodiments, the display screen 216 may be flush with the top surface 102 of the table top 101. The display screen 216 may be mounted for selective removal from the table top 101. In some applications, the display screen 216 may be a touch-controlled display screen, in which case operation of the content display device 200 is facilitated by touching of the display screen 216. The display screen 216 may be an LCD (active matrix or passive matrix), an active matrix OLED or a passive matrix OLED, a CRT or a plasma screen and may be any of various sizes and shapes (square, round or panoramic, for example). In some applications, the plane of the display screen 216 may be disposed at a selected angle with respect to the plane of the top surface 102 of the table top 101.

The data cable 212 (FIG. 7) is adapted for connection of the content display device 200 to the Internet and/or to one or multiple database servers 120 (FIG. 1). Additionally or alternatively, an antenna 220 may be connected to the circuit board 210 such as via antenna wiring 220a. In the system 300, the data cable 212 and/or the antenna 220 define the links of communication between the content display device 200 and the corresponding information transfer pathway 200a (FIG. 2) which interfaces with the marketing management software 301. The antenna 220 is adapted to receive information wirelessly from the marketing management software 301 through the information transfer pathway 200a.

The circuit board 210 includes the various components which initiate and sustain operation of the content display device 200, according to technology which is well known by those skilled in the art. The circuit board 210 is adapted to receive the completed advertisements in electronic form from the marketing management software 301 through the information transfer pathway 200a (typically via the data cable 212 and/or the antenna 220) and display the advertisements on the display screen 216. Accordingly, the circuit board 210 may present the completed advertisements in the form of advertising images, for example, on the display screen 216 as illustrated in FIG. 1. The advertising images may correspond to photos or images of various products offered by an advertiser 304 (FIG. 2) in implementation of the system 300. The circuit board 210 may have the capability to run a flash application which has the capability to continually update and display completed advertisements on the display screen 216.

As illustrated in FIG. 1, the content display device 200 may include the capability to facilitate selective 180-degree rotation of the advertising images displayed on the display screen 216. This may be facilitated by touching of the display screen 216, for example. In some embodiments, multiple image orientation sensors 214 may be provided on the table top 101, such as along the side surfaces 103, for example. Each image orientation sensor 214 is connected to the circuit board 210 (FIG. 7) and is adapted to sense the position of a person or persons (not illustrated) sitting or standing adjacent to the table 100. Each image orientation sensor 214 provides input to the circuit board 210 which, in response, orients the advertising images displayed on the display screen 216 for proper observation by the person or persons.

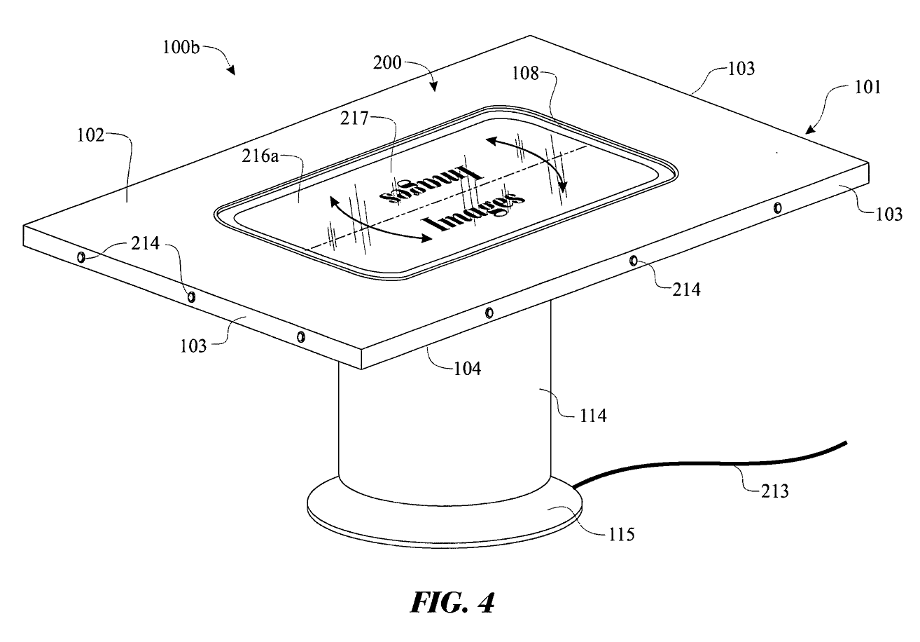

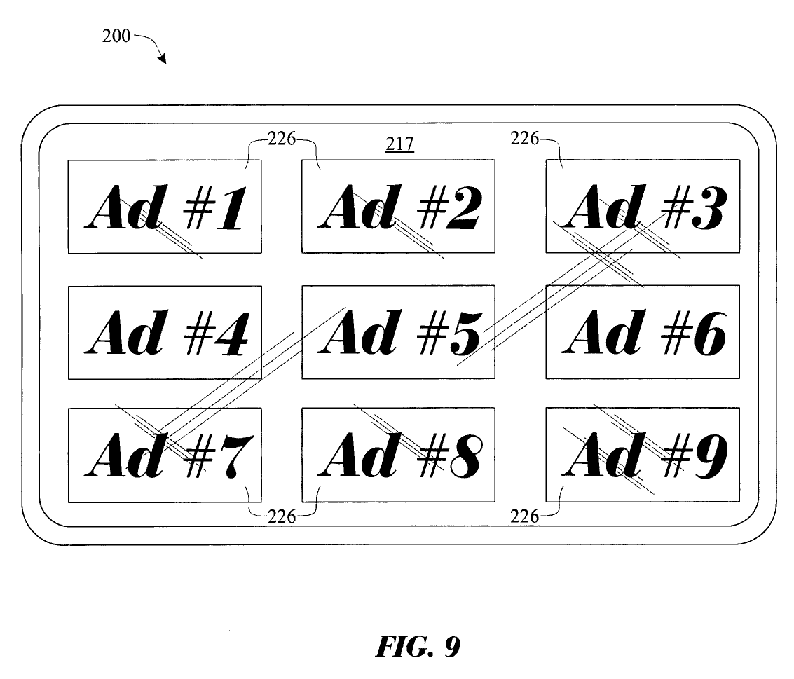

As illustrated in FIG. 4, in some embodiments of the system 100b, the circuit board 210 (FIG. 7) of the content display device 200 may be adapted to present a split-screen image display configuration on the display screen 216 and may include a pair of screen sections 216a for this purpose. The respective screen sections 216a may be oriented to display discrete advertising images for viewing from opposite sides of the table top 101, for example. As illustrated in FIG. 9, in some applications the circuit board 210 (FIG. 7) of the content display device 200 may be adapted to present multiple advertisement display sections 226 on the display screen 216. In operation of the table 100, different advertisements can be simultaneously presented in the respective advertisement display sections 226.

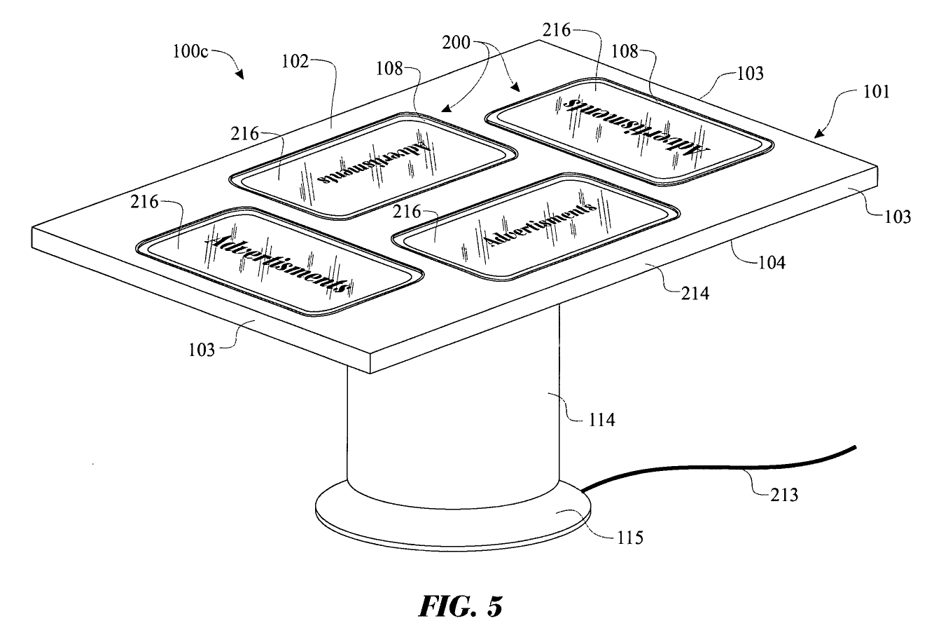

As illustrated in FIG. 5, in another illustrative embodiment of the table 100c, multiple content display devices 200 are provided in the table top 101 in any desired orientation and pattern. In some embodiments, the content display devices 200 may be oriented in generally parallel relationship with respect to the respective side surfaces 103 of the table top 101. Accordingly, advertisements presented on the display screen 216 of each content display device 200 are oriented for proper observation by persons seated or standing at respective positions around the table 100c.

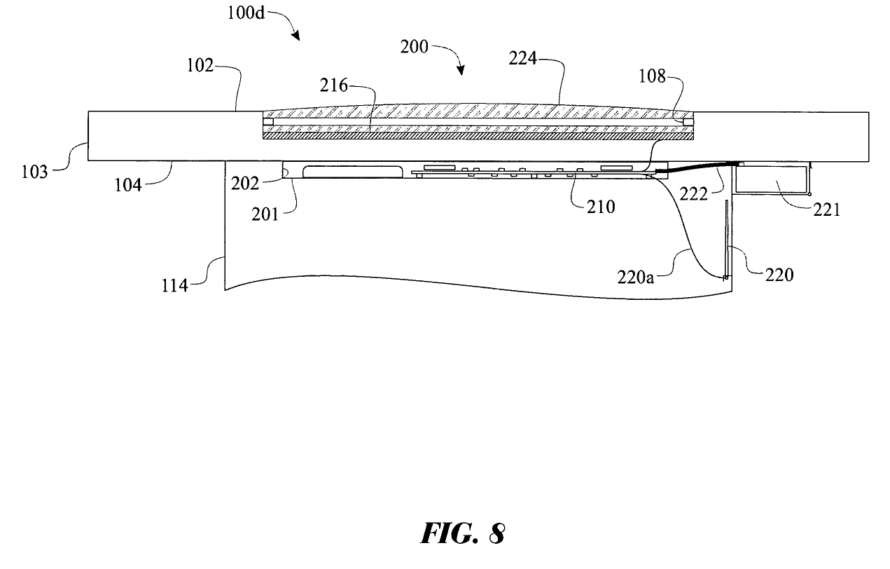

As illustrated in FIG. 8, in another illustrative embodiment of the table 100d, a magnified lens 224 is provided in the display cavity 108, over the display screen 216. The magnified lens 224 is adapted to magnify advertising images displayed on the display screen 216. Additionally or alternatively, a battery 221, which may be rechargeable or disposable, is electrically connected to the circuit board 210 such as via battery wiring 222. The battery 221 is adapted to supply electrical power to the content display device 200. The battery 221 may be lithium, Ni-Mi, Ni—Cd or may be a direct methanol fuel cell or solar-powered, for example. The battery 221 may have the capability for remote charging using powercast technology.

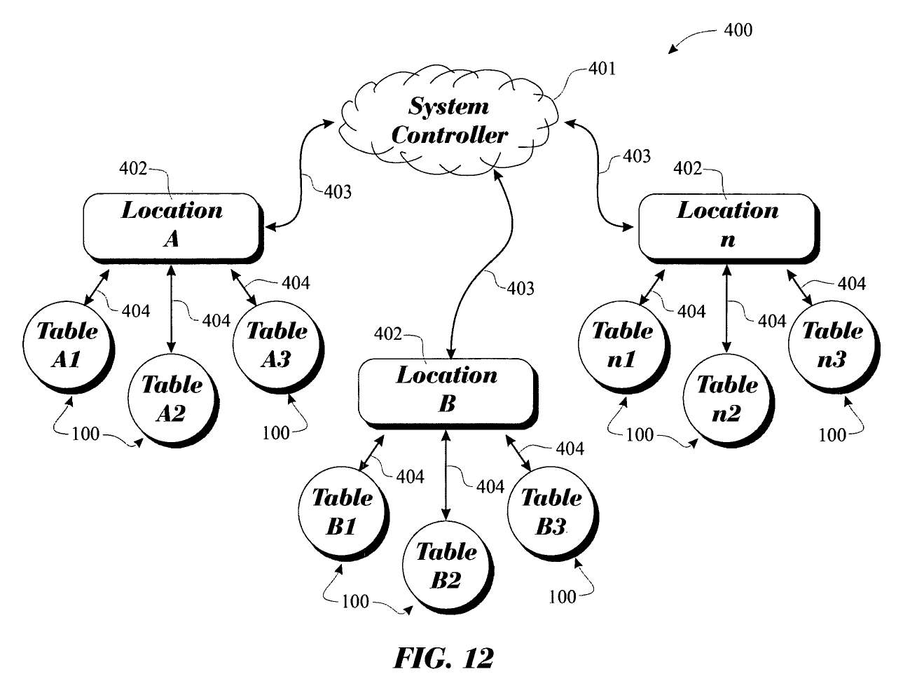

Referring next to FIG. 12 of the drawings, a suitable control system 400 for each of multiple tables 100 is illustrated. The control system 400 includes a system controller 401. Various local controllers 402 of the tables 100 may be arranged in different areas of the same building (not illustrated) or in different buildings, for example. The system controller 401 communicates with each local controller 402 through a corresponding system communication pathway 403. Through a corresponding local communication pathway 404, each local controller 402 communicates with the circuit board 210 (FIG. 7) of the content display device 200 on each table 100 which is controlled by that local controller 402. Through each local controller 402, the system controller 401 may be adapted to control such parameters as the content and/or order of advertisements presented on the display screen 216 (FIG. 7) of each table 100. The system controller 401 may be further adapted to control various aspects of the advertising images (such as brightness and contrast, for example), which are presented on the display screen 216.

Referring again to FIG. 2 of the drawings, in typical application of the system 300, each of multiple advertisers 304 who seek to display an advertisement or advertisements which relate to the products and/or services offered by one or more of the advertisers 304 subscribes to use the system 300 to advertise the goods and/or services to potential customers. One or multiple tables 100 is/are placed in a restaurant, cafeteria, mall, club, hospital waiting area, coffee shop, airport or other area in which potential customers will stand or sit around the table 100. The advertisements of the advertisers 304 are loaded in electronic form into the client advertisements database 302. The advertisements stored in the client advertisements database 302 may include such information as photos, images, descriptive text and/or videos which are directed to the products and/or services offered by each of the advertisers 304. The advertisements are transferred from the client advertisements database 302 to the marketing management software 301 through the information transfer pathway 302a. In some embodiments, the marketing company 303 may augment, modify and/or edit the advertisements stored by the marketing management software 301 for marketing presentation purposes. The modified and/or edited and completed advertisements are transferred from the marketing management software 301, through each corresponding information transfer pathway 200a to the content display device 200 of the table 100 for display on the display screen 216 of the content display device 200. Accordingly, potential customers (not illustrated) of the goods and/or services offered by an advertiser 304 are seated or stand adjacent to the table 100 and can view the advertisement or advertisements on the display screen 216 of the content display device 200. In a restaurant setting, for example, the potential customers may be patrons of the restaurant who sit at the table 100 and view the advertisements while waiting for a dining order to be completed. In a college cafeteria setting, the table 100 can be a cafeteria tables in which multiple content display devices 200 are placed, as was heretofore described with respect to the table 100c illustrated in FIG. 5. Each content display device 200 may be used to display upcoming scholastic events, sports and announcements, for example.

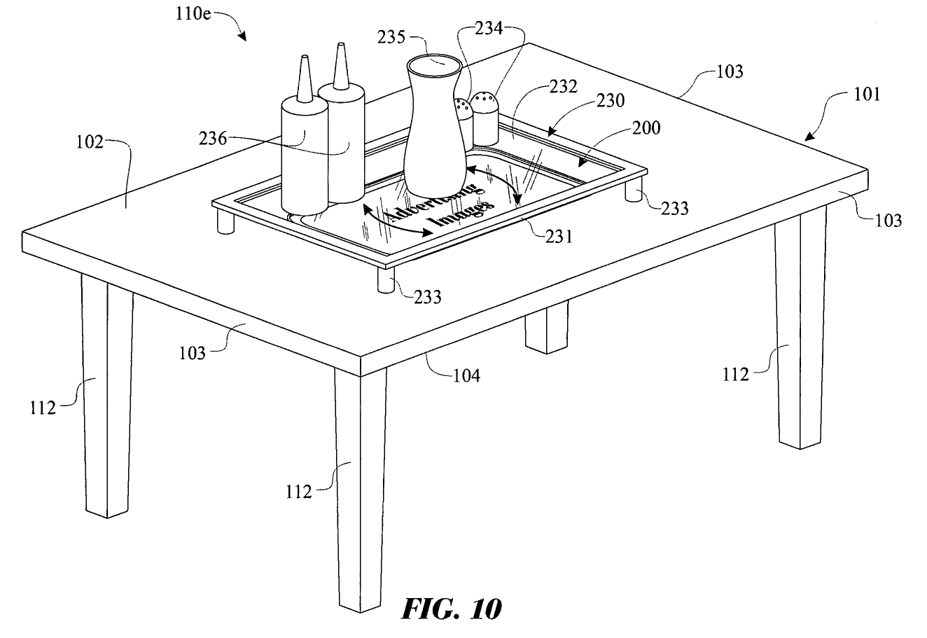

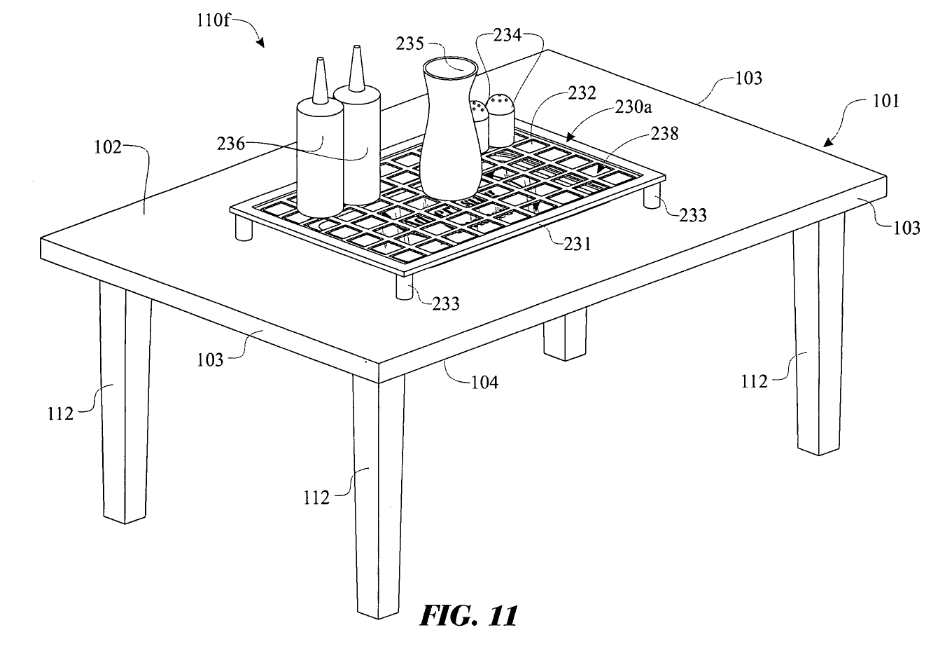

Referring next to FIGS. 10 and 11 of the drawings, still another illustrative embodiment of the system 100e (FIG. 10) includes a support tray 230 which is provided on the table top 101 of the table 100 to support various items such as salt and pepper shakers 234, a pitcher 235 and ketchup and mustard containers 236, for example. The support tray 230 may include a support tray frame 231. A solid transparent glass or plastic support tray panel 232 is supported by the support tray frame 231. Support tray legs 233 may extend from the support tray panel 232 to support the support tray 230 on the top surface 102 of the table top 101. In the embodiment of the system 100f which is illustrated in FIG. 11, a grid panel 238 is provided on the support tray frame 231 in place of the solid support tray panel 232 of the support tray 230 in FIG. 10.

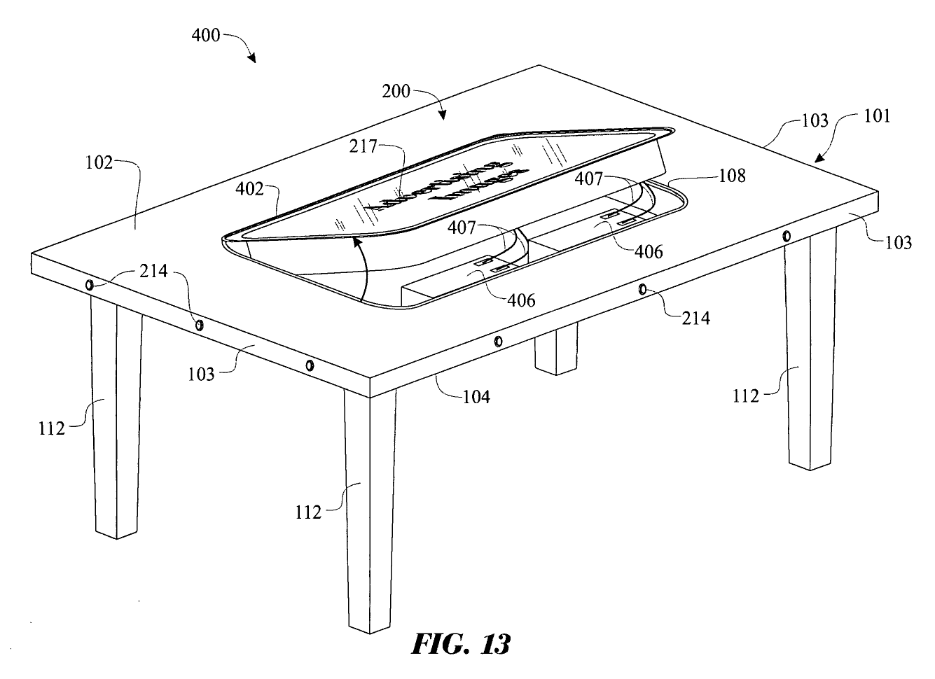

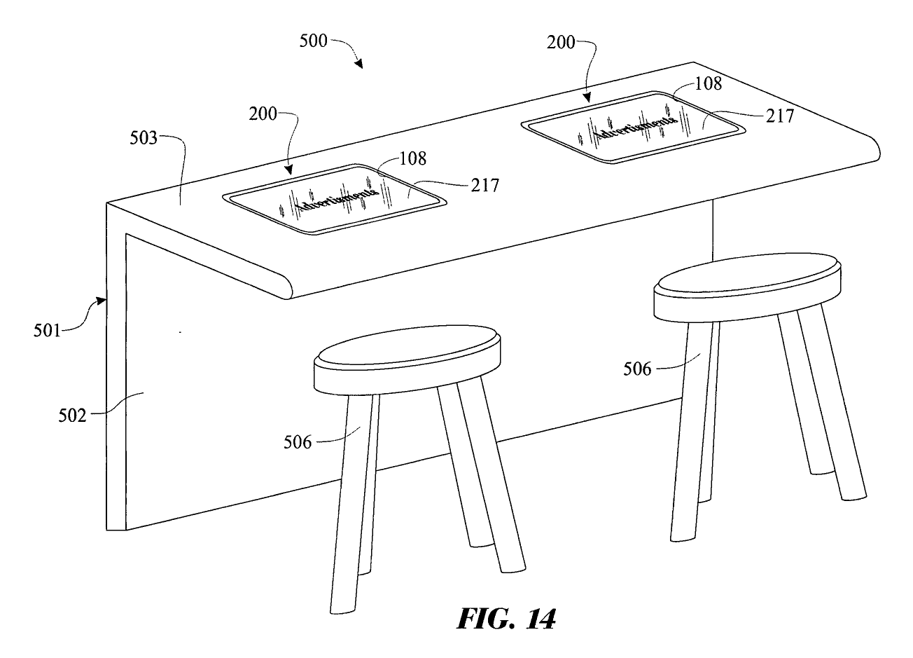

Referring next to FIG. 13 of the drawings, in yet another illustrative embodiment of the system 400, the content display device 200 is pivotally attached to an edge of the display cavity 108 along a display device hinge 402. Accordingly, the content display device 200 can be selectively pivoted to lie in the display cavity 108 such that the screen cover panel 217 is generally flush or coplanar with the table top 101. Alternatively, the content display device 200 can be selectively pivoted from the display cavity 108 such that the screen cover panel 217 is oriented at an angle with respect to the table top 101, as illustrated. This facilitates the viewing of images on the screen cover panel 217 by a person or persons (not illustrated) seated at an edge of the table top 101. Batteries 406 which are connected to the content display device 200 via battery wiring 407, as well as other components (not illustrated) of the content display device 200, may be accessed in the display cavity 108 for repair, replacement and/or maintenance purposes by pivoting the content display device 200 to the angled position illustrated in FIG. 13.

Referring next to FIG. 14 of the drawings, in another illustrative embodiment of the system 500, a bar table 501 may include a vertical support 502 and a bar table top 503 which extends from the vertical support 502. At least one content display device 200 is provided in at least one display cavity 108 provided in the bar table top 503. In some embodiments, multiple content display devices 200 may be provided in spaced-apart relationship with respect to each other along the bar table top 503. Accordingly, patrons (not illustrated) may stand at the bar table top 503 or sit at respective bar stools 506 which are positioned at the respective content display devices 200 along the bar table top 503 and view advertisements which are displayed on the screen cover panel 217 of each content display device 200.

While the preferred embodiments of the invention have been described above, it will be recognized and understood that various modifications can be made in the invention and the appended claims are intended to cover all such modifications which may fall within the spirit and scope of the invention.

I claim:

1. An advertisement management and display system, comprising:
marketing management software;
a client advertisements database communicating with said marketing management software;
at least one table;
at least one content display device carried by said at least one table and communicating with said marketing management software; and
wherein said client advertisements database is adapted to store at least one advertisement, said marketing management software is adapted to receive said at least one advertisement from said client advertisements database and said at least one content display device is adapted to receive said at least one advertisement from said marketing management software and display said at least one advertisement.

2. The system of claim 1 further comprising a marketing company communicating with said marketing management software and adapted to modify said at least one advertisement.

3. The system of claim 1 further comprising at least one advertiser interfacing with said client advertisements database.

4. The system of claim 1 wherein said at least one content display device comprises a plurality of content display devices.

5. The system of claim 1 wherein said at least one table comprises a table top and a plurality of table legs extending from said table top, and wherein said at least one content display device is carried by said table top.

6. The system of claim 1 wherein said at least one table comprises a table top and a central table top support extending from said table top, and wherein said at least one content display device is carried by said table top.

7. The system of claim 1 wherein said at least one content display device comprises a display cavity provided in said at least one table, a display screen provided in said display cavity, a circuit board connected to said display screen and a power cord connected to said circuit board.

8. The system of claim 7 wherein said display screen comprises a touch-activated display screen.

9. The system of claim 7 further comprising a support tray carried by said at least one table.

10. The system of claim 9 wherein said support tray comprises a support tray frame, a support tray panel carried by said support tray frame and a plurality of legs extending from said support tray frame and carried by said at least one table.

11. The system of claim 10 wherein said support tray panel comprises a solid transparent material.

12. The system of claim 10 wherein said support tray panel comprises a grid panel.

13. An advertisement management and display system, comprising:
marketing management software;
a client advertisements database communicating with said marketing management software;
at least one table;
at least one content display device carried by said at least one table and communicating with said marketing management software;
wherein said client advertisements database is adapted to store at least one advertisement, said marketing management software is adapted to receive said at least one advertisement from said client advertisements database and said at least one content display device is adapted to receive said at least one advertisement from said marketing management software and display said at least one advertisement; and
a control system interfacing with said at least one content display device.

14. The system of claim 13 wherein said control system comprises a system controller and at least one local controller communicating with said system controller and said at least one table.

15. The system of claim 13 further comprising a marketing company communicating with said marketing management software and adapted to modify said at least one advertisement.

16. The system of claim 13 further comprising at least one advertiser interfacing with said client advertisements database.

17. A table with electronic display capability, comprising:
a table top;
at least one content display device carried by said table top; and
wherein said at least one content display device comprises:
a display screen carried by said table top;
a circuit board connected to said display screen;
at least one database server storing information connected to said circuit board; and
wherein said circuit board is adapted to receive said information from said at least one database server and display said information on said display screen.

18. The table with electronic display capability of claim 17 wherein said display screen comprises a touch-activated display screen.

19. The table with electronic display capability of claim 17 wherein said display screen comprises a split display screen comprising a pair of screen sections.

20. The content display device of claim 17 further comprising at least one of a data cable and an antenna connected to said circuit board and said at least one database server.
